(19) United States
(12) Patent Application Publication
(10) Pub. No.: US 2018/0088926 A1
(43) Pub. Date: Mar. 29, 2018

(54) CONTAINER IMAGE MANAGEMENT USING LAYER DELTAS

(71) Applicant: CA, Inc., Islandia, NY (US)

(72) Inventor: Howard A. Abrams, San Mateo, CA (US)

(21) Appl. No.: 15/277,839

(22) Filed: Sep. 27, 2016

(51) Int. Cl. G06F 9/445; H04L 29/08

(52) U.S. Cl. CPC G06F 8/65; H04L 67/2842; H04L 67/34

(57) ABSTRACT

In one embodiment, a request for an updated version of a container image may be received from a client device, the request comprising an identification of a previous version of the container image. A delta may be determined between container layers of the previous version of the container image and the updated version of the container image. A patch may be generated, based on the delta, to generate the updated version of the container image when the patch is applied to the previous version of the container image. The patch may then be transmitted to the client device.

### BACKGROUND

The present disclosure relates in general to the field of software development, and more specifically, to managing software container images using layer deltas.

As software applications become increasingly sophisticated, their complexity also increases, along with the number and variety of underlying components. Developing a complex software application may be challenging, as its numerous components must each be developed, configured, tested, and maintained. For example, a microservices application implemented using software containers may include a variety of different container images for its various microservices. Ensuring that the container images of the application are updated may be challenging, as it may be time-consuming and may require sufficient network bandwidth and/or storage resources.

### BRIEF SUMMARY

According to one aspect of the present disclosure, a request for an updated version of a container image may be received from a client device, the request comprising an identification of a previous version of the container image. A delta may be determined between container layers of the previous version of the container image and the updated version of the container image. A patch may be generated, based on the delta, to generate the updated version of the container image when the patch is applied to the previous version of the container image. The patch may then be transmitted to the client device.

### BRIEF DESCRIPTION OF THE DRAWINGS

FIG. 1 illustrates a simplified schematic diagram of an example computing environment for software applications.

FIG. 2A illustrates a simplified block diagram of an example software development system.

FIG. 2B illustrates a simplified block diagram of an example software registry.

FIG. 3A illustrates an example use case of container image management for squashed images.

FIG. 3B illustrates an example use case of container image management for dependent images.

FIG. 4A illustrates an example monolithic architecture for a software application.

FIG. 4B illustrates an example microservices architecture for a software application.

FIG. 5 illustrates an example software container environment.

FIG. 6 illustrates an example application modeling and development tool.

FIG. 7 illustrates a flowchart for an example embodiment of server-side container image management using layer deltas.

FIG. 8 illustrates a flowchart for an example embodiment of client-side container image management using layer deltas.

FIG. 9 illustrates a flowchart for an example embodiment of pushing container images using layer deltas.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

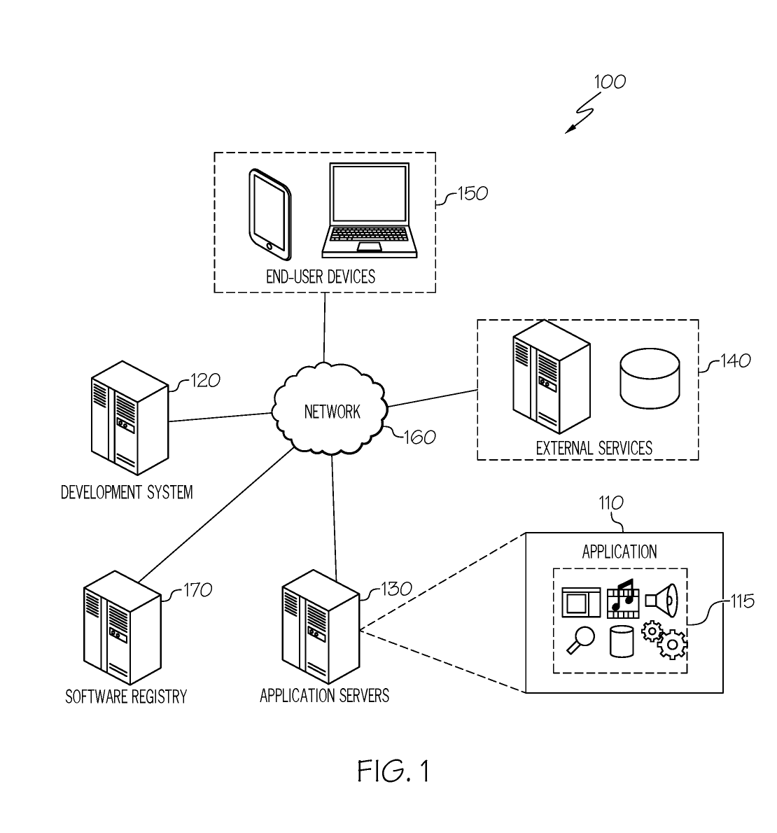

FIG. 1 illustrates a simplified schematic diagram of an example computing environment 100 for software applications. In some embodiments, computing environment 100 may include functionality for container image management using layer deltas, as described throughout this disclosure.

The illustrated computing environment 100 includes software application 110, application servers 130, external services 140, software development system 120, and software registry 170, among other hardware and software computing elements. In some implementations, functionality of the various illustrated components, and other associated systems and tools, may be combined or even further divided and implemented among multiple different systems.

Application 110 may be any type of software that is developed and/or hosted in computing environment 100. For example, application 110 may be a software application, program, library, module, or portion of a larger, multi-tiered software system (collectively referred to herein as a software “component”). Application 110 may be developed using software development system 120. In addition, application 110 may be hosted or deployed on one or more application servers 130. Application 110 may be implemented using a monolithic architecture, a microservices architecture, or any other software design approach. A monolithic application may be implemented as a single application that integrates all associated components and functionality. A microservices application may be implemented using multiple separate and self-contained applications, or microservices 115, that each provide a particular service and collectively form a fully functional application. A microservices architecture may allow each underlying microservice 115 of an application 110 to be independently developed, deployed, updated, and scaled, resulting in numerous efficiencies in the software development process. In some cases, an application 110 may also be implemented using software containers (e.g., Docker containers, Open Container Initiative (OCI) based containers, and/or any other software container implementation). Analogous to shipping containers, software containers may package a particular software component with all of its dependencies to ensure that it runs the same in any environment or infrastructure, out-of-the-box. For example, a software container may package everything required to run a particular software component, such as the code, software libraries, configuration, files, runtime environment, and any other associated tools or applications. Software containers may also share a host operating system, thus avoiding the inefficiencies of virtual machines which each require their own guest operating system on top of the host operating system. Microservices applications may be implemented using software containers, for example, by packaging each microservice 115 of an application 110 into separate software containers.

Application servers 130 may host software developed using software development system 120, such as software application 110. Application servers 130 may provide a server environment for running the application 110 and interfacing with its end-users 150. For example, application servers 130 may host web applications for websites, mobile back-ends for mobile applications, databases, and service-based applications (e.g., applications that provide services to other applications), among other examples. Applications 110 hosted on application servers 130 may utilize, consume data and services of, provide data or services to, or otherwise be at least partially dependent on, or function in association with, one or more other software components or applications hosted on the same server system (e.g., application server 130) or a different server system (e.g., external services 140). Applications 110 may be hosted on systems of a single entity or may be distributed among systems controlled by one or more third parties, among other examples.

External services 140 may be third party services used by application 110. For example, external services 140 may be implemented by software components and/or databases hosted by a third party to provide a particular service, such as cloud services, audio and video streaming, messaging, social networking, mapping and navigation, user authentication, payment processing, news, and weather, among other examples. In some embodiments, external services 140 may be hosted by third parties using application servers and/or database servers.

Software development system 120 may facilitate development, configuration, testing, deployment, and/or maintenance of software, such as software application 110. For example, development system 120 may include tools and functionality for use in the software development cycle, including integrated development environments (IDE), application modeling, configuration, version control, compiling, testing, debugging, runtime monitoring, deployment, and maintenance, among other examples. Systems and services that facilitate software development (e.g., development system 120 and software registry 170) may be provided local to, or remote from (e.g., over network 160), the end-user devices 150 of software developers, and/or the target systems used to host the software (e.g., application servers 130 and external services 140).

Software registry 170 may host a repository of software packages that can be used by or used with a particular software application 110, including software libraries or environments, application programming interfaces (APIs), other software applications or components (e.g., database servers, web servers), and operating systems, among other examples. For example, application 110 may rely on a variety of existing software packages, and during development of application 110, development system 120 may obtain the appropriate software packages for building application 110 from software registry 170. Throughout the life of the application 110, development system 120 may also obtain any new versions, releases, updates, patches, bug fixes, or other revisions to those associated software packages. Software packages hosted by software registry 170 may be stored, in some embodiments, using software images corresponding to particular software packages. For example, software packages that are implemented using software containers may be stored in software registry 170 using container images, which may include all components and dependencies required to run a particular software package in a software container. A container image may be a file format used to package the components and dependencies of a containerized software package, such as Docker container images, Open Container Initiative (OCI) based images, and/or any other container image format.

End-user devices 150 may include any type of device that allows a user to interact with the components of computing environment 100. For example, software developers may utilize end-user devices 150 to develop software (e.g., application 110) using software development system 120. As another example, users of a software application 110 may utilize end-user devices 150 to access the application. End-user devices 150 may interact with components of computing environment 100 either locally or remotely over a network 160. For example, in some embodiments, software developers may utilize end-user devices 150 that are local to or integrated with the development system 120, while in other embodiments software developers may utilize end-user devices 150 that interact with the development system 120 over a network 160. End-user devices 150 may include, for example, desktop computers, laptops, tablets, mobile phones or other mobile devices, wearable devices (e.g., smart watches, smart glasses, headsets), smart appliances (e.g., televisions, audio systems, home automation systems, refrigerators, washer/dryer appliances, heat-ventilation-air-conditioning (HVAC) appliances), and the like.

One or more networks 160 may be used to communicatively couple the components of computing environment 100, including, for example, local area networks, wide area networks, public networks, the Internet, cellular networks, Wi-Fi networks, short-range networks (e.g., Bluetooth or ZigBee), and/or any other wired or wireless communication medium. For example, users of application 110 may access the application remotely over a network 160 on application servers 130 using end-user devices 150. As another example, application 110 may utilize external services 140 that are accessed remotely over a network 160. As another example, software developers may access development system 120 remotely over a network 160 using end-user devices 150. As another example, development system 120 may obtain software images remotely over a network 160 from software registry 170.

In general, elements of computing environment 100, such as “systems,” “servers,” “services,” “registries,” “devices,” “clients,” “networks,” and any components thereof (e.g., 120, 130, 140, 150, 160, and 170 of FIG. 1), may include electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing environment 100 (e.g., 120, 130, 140, 150, 160, and 170 of FIG. 1) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, in some implementations, development system 120, application servers 130, external services 140, software registry 170, and/or any other sub-system or component of computing environment 100, may be at least partially (or wholly) cloud-implemented, web-based, or distributed for remotely hosting, serving, or otherwise managing data, software services, and applications that interface, coordinate with, depend on, or are used by other components of computing environment 100. In some instances, elements of computing environment 100 (e.g., 120, 130, 140, 150, 160, and 170 of FIG. 1) may be implemented as some combination of components hosted on a common computing system, server, server pool, or cloud computing environment, and that share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Software applications 110, such as those developed and deployed in example computing environment 100, are becoming increasingly sophisticated. As software applications 110 become more sophisticated, their complexity also increases, along with the number and variety of underlying components 115. Many modern software applications 110, for example, may be composed of a variety of underlying components 115. A microservices application 110, for example, may include many different microservices 115. Developing a complex software application 110 may be challenging, as its numerous components 115 must each be developed, configured, tested, and maintained or updated. Development of an application 110, for example, may involve multiple separate development teams and/or entities that are each responsible for developing different components 115. Configuring a complex software application 110 may also be challenging, particularly as the number of underlying components 115 increases, as it may involve tailored configurations of each component of the application. Testing a complex software application 110 may also be challenging, as it may involve numerous complex tests, using many different test cases and use cases, of both the underlying components 115 individually and the application 110 as a whole. Creating the test cases for testing an application 110 may itself be a complex and time-intensive undertaking. Updating and maintaining a software application 110 may also be challenging. For example, because the various components 115 of the application 110 may be developed by different development teams and/or entities, new versions of each underlying component 115 may be developed independently, and thus the timing and frequency of new version releases may vary for each underlying component 115 of the application 110.

For example, a microservices application 110 implemented using software containers may include a variety of different software containers and associated container images for the various microservices 115 of the application. Software containers, such as Docker containers, are becoming very popular. Software containers, for example, may be runtime instantiations of container “images.” An image may be made up of multiple layers that can be shared between containers for greater efficiency. Layers may be read-only, such that changes are made by adding new layers on top of the existing layers. New images may be created by referencing an existing image (e.g., an image for Apache Tomcat could be created by adding Tomcat on top of an existing “Java” image). For example, if you start with container “A” and modify a file within the container and save off the image as “B”, under the hood the layer for “A” remains and a new layer for “B” is created. Similarly, the same thing could be done to create an image “C”, which would create a new layer for “C”. At runtime, if two Docker containers were stood up for “B” and “C”, Docker would instantiate two filesystems that contained the layers for “B” and “C”, on top of a shared layer for “A”. While this layering can continue forever, in practice files get duplicated when they are modified, and eventually the layering may become very inefficient. To save space, as a best practice developers often “squash” their layers, consolidating them into a single layer. While this may save space by eliminating duplicative files, it means developers using the image must download the entire image every time a change is made. This is most common with “base” images that contain the operating system files. For example, frequently there are new Docker images for CentOS (a Linux distribution) that contain the latest operating system patches and updates. Although very little may change between each version, a developer must download each version separately and completely if the changes are not stored in separate layers.

Thus, in theory, only new layers must be transferred and stored when upgrading to a newer version of an image. In practice, however, there are two problems with transferring only new layers. First, images can become large when many layers are added (e.g., when multiple layers change the same file, that file may be duplicated in each of those layers), so often they are “squashed” into one single layer. For example, when an image includes multiple layers with different versions of the same file, the file must be duplicated for each layer. If a large file in an image is updated 20 times, the image may include separate layers for each update, and thus may contain 20 copies of the file. While the layers may be squashed into a single layer to save space, the squashed image loses the efficiencies of having multiple layers, requiring the entire new image to be transferred to developers using the image.

In addition, when a lower layer of an image is changed or updated, dependent layers and images must be rebuilt, even if they are otherwise unchanged. The result is that a single small change in a lower level layer, such as a glibc patch in an operating system image, may result in the need to download and store entire sets of images. For example, if an application image is built on top of (i.e., dependent on) multiple other images, including a CentOS base image, and a 20-byte change is made to a library in CentOS, the images built on top of CentOS must be rebuilt in order to have the proper set of layers on top of the updated CentOS image. Given that there may be many different applications whose container images are built on top of CentOS, those images would similarly need to be rebuilt.

As software development trends towards continuous delivery of software (i.e., continuously pushing new changes into production rather than sporadically releasing new functionality), these efficiencies in managing container images may require transferring large volumes of data (e.g., multiple gigabytes or more) multiple times a day, creating a bottleneck in the software development process.

In some embodiments, layer deltas may be used to facilitate management and updates of container images. For example, deltas may be calculated between image layers for different versions of the same container image (e.g., using a binary delta calculation), and a patch may then be created based on the delta calculations. The patch can then be transmitted to developers who request the updated container image, rather than transmitting the entire updated container image or even the entire new image layers. The patch can then be applied to the previous version of the container image to generate the updated version of the container image. In some embodiments, for example, a software developer using development system 120 may request an updated container image from software registry 170, and may also identify its existing version of the container image. Software registry 170 may generate and/or store the patch for the updated container image, and may then transmit the patch to development system 120 to allow the software developer to generate the updated container image by applying the patch to the existing container image.

Delta or difference calculations have not previously been used in conjunction with container images and their associated metadata. Because of the way container images are structured with multiple layers, the use of delta calculations in this manner is novel, as it is neither the same nor as straightforward as generic data transfer using binary delta calculations. Managing container images using layer deltas provides many benefits, including significant savings in bandwidth and storage space (e.g., by a factor of 10×-100× in certain cases). It also removes the bottlenecks that result from transmitting entire container images, facilitates continuous software delivery, saves time, and reduces the overall burden of developing and maintaining complex software applications. In this manner, managing container images using layer deltas significantly improves the software development process.

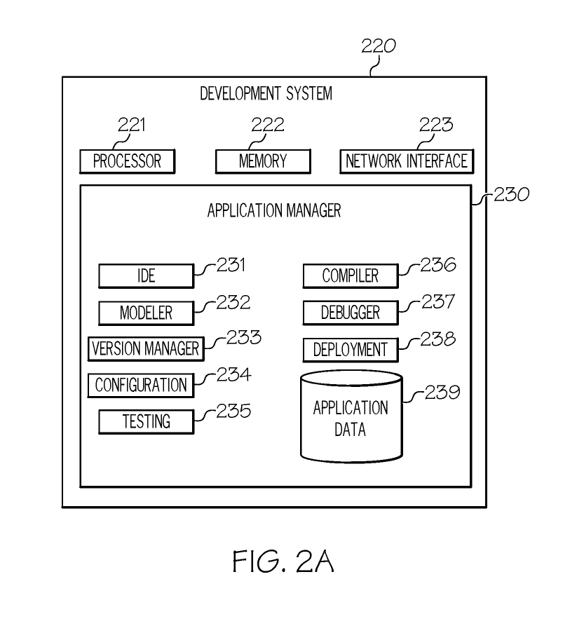

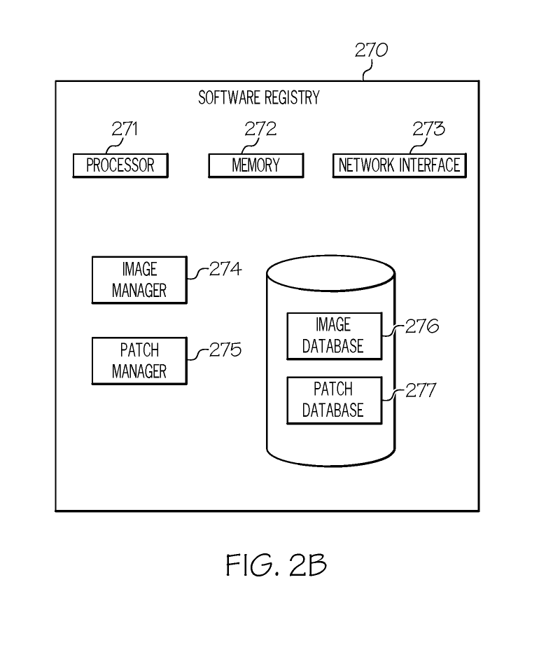

FIG. 2A illustrates a simplified block diagram of an example software development system 220, and FIG. 2B illustrates a simplified block diagram of an example software registry 270. In some embodiments, software development system 220 and/or software registry 270 may include functionality for container image management using layer deltas, as described throughout this disclosure.

Software development system 220 may facilitate development, testing, deployment, and/or maintenance of software, such as software applications, programs, libraries, modules, or other software components (e.g., components of larger, multi-tiered software systems). In some embodiments, for example, software development system 220 may be used to implement the functionality of software development system 120 of FIG. 1. In certain embodiments, software development system 220 may include one or more processors 221, memory elements 222, and network interfaces 223, along with application development software, such as application manager 230. In some implementations, the various illustrated components of development system 220, and other associated systems and tools, may be combined, or even further divided and distributed among multiple different systems. For example, in some implementations, development system 220 may be implemented as multiple different systems with varying combinations of the foregoing components (e.g., 221, 222, 223, 230). Components of development system 220 may communicate, interoperate, and otherwise interact with external systems and components (including with each other in distributed embodiments) over one or more networks using network interface 223.

Application manager 230 may include a collection of components, functionality, and/or tools for facilitating development of software applications (e.g., application 110 of FIG. 1). For example, in some embodiments, application manager 230 may include integrated development environment (IDE) 231, application modeler 232, version manager 233, configuration module 234, testing module 235, compiler 236, debugger 237, deployment module 238, and/or application data storage 239, among other potential components, functionality, and tools (along with any combination or further division, distribution, or compartmentalization of the foregoing). In some embodiments, application manager 230, and/or its underlying components, may be implemented using machine executable logic embodied in hardware- and/or software-based components. In some embodiments, application data storage 239 may be used to store information associated with applications developed using development system 220, such as source code, configurations, version information, application models, and testing models, among other examples.

In some embodiments, development system 220 may include an integrated development environment (IDE) 231 to provide a comprehensive development environment for software developers. IDE 231, for example, may be a software development application with a user interface that integrates access to a collection of software development tools and functionality. For example, IDE 231 may integrate functionality for source code editing, intelligent code completion, application modeling, graphical user interface (GUI) building, version management and control, configuration, compiling, debugging, testing, and/or deployment. The boundary between an integrated development environment (e.g., IDE 231) and other components of the broader software development environment (e.g., software development system 220) may vary or overlap. In some embodiments, for example, IDE 231 may provide an interface that integrates the various components and tools of application manager 230, such as application modeler 232, version manager 233, configuration module 234, testing module 235, compiler 236, debugger 237, and/or deployment module 238.

In some embodiments, development system 220 may include an application modeler 232 to model the architecture of a software application. Software applications may be composed of, include, and/or rely on a variety of underlying software components. For example, applications may be implemented using a variety of software design approaches (e.g., monolithic or microservices architectures), and with a variety of software modules, components, containers, services, microservices (e.g., microservices 115 of FIG. 1), and/or external services (e.g., external services 140 of FIG. 1), among other examples. Microservices applications, for example, may be implemented by packaging a variety of microservices into separate software containers. Application modeler 232 may be used to design, configure, and/or update the architecture of a software application and its underlying components. For example, application modeler 232 may be used to design or configure an application by identifying each underlying component, along with its functionality and responsibilities, configuration, version, and relationship to other components, among other information. This configuration information for the application may be stored by the application modeler 232, for example, using application data storage 239. Application modeler 232 may also display a graphical representation of the application's design or architecture. For example, application modeler 232 may display graphical representations of each underlying software component of the application (including, for example, the name, version, and/or configuration of each component), the relationships between the underlying components, and so forth. In addition, in some embodiments, application modeler 232 may also provide or facilitate container management using layer deltas, for example, as described in connection with version manger 233.

In some embodiments, development system 220 may include a compiler 236 to compile and/or build applications, for example, by compiling the source code of an application developed using development system 220. In some embodiments, development system 220 may also include a debugger 237 to debug applications that are developed using development system 220.

In some embodiments, development system 220 may include a testing module 235 to test software applications that are developed using development system 220. Testing an application may involve numerous complex tests, using many different test cases and use cases, of both the underlying components individually and the application as a whole. Creating the test cases for testing an application may itself be a complex and time-intensive undertaking. In some embodiments, testing module 235 may include model-based testing functionality to facilitate application testing.

In some embodiments, development system 220 may include a deployment module 238 to deploy applications that are developed using development system 220. For example, once an application has been developed, deployment module 238 may be used to deploy the application for live use by end-users. In some embodiments, for example, deployment module 238 may deploy the application on one or more live production servers, such as application servers 130 of FIG. 1.

In some embodiments, development system 220 may include a configuration module 234 to configure applications that have been developed, or are being developed, using software development system 220. For example, configuration module 234 may be used to configure underlying software components, software containers (e.g., Docker containers, Open Container Initiative (OCI) based containers, and/or any other software container implementation), microservices, microservice containers, software images, databases, web servers, external services, network connections, filesystems, runtime environments, and deployment environments of an application, among other examples.

In some embodiments, development system 220 may include a version manager 233 to facilitate version control and management for software applications. For example, version manager 233 may include a version control system. Version control systems, for example, may be used by software developers to manage changes to software, simultaneously work on different aspects and/or versions of the software, and recover previous versions of the software when needed. For example, version control systems may record the changes to files over time, allowing developers to revert files back to a previous state, revert an entire project back to a previous state, compare changes over time, identify authors and dates for particular files and/or revisions, and so forth. Version manager 233 may also be used to manage updates to the various packages used by software applications. For example, a software application may rely on a variety of existing software packages or components, including container images, software libraries or environments, application programming interfaces (APIs), other software applications or components (e.g., database servers, web servers), and operating systems, among other examples. During development of a software application, development system 220 may obtain the appropriate software packages for building the application, for example, from a software registry (e.g., software registry 270 of FIG. 2B). Throughout the life of the application, new versions of the underlying software packages used by the application may be released (e.g., new versions, releases, updates, patches, bug fixes, or any other revisions). Version manger 233 may facilitate updating the software application, when appropriate, with new versions of its underlying software packages.

Software registry 270 (of FIG. 2B) may host a repository of software packages that can be used by or used with a particular software application (e.g., application 110 of FIG. 1), including container images, software libraries or environments, application programming interfaces (APIs), other software applications or components (e.g., database servers, web servers), and operating systems, among other examples. In some embodiments, for example, software registry 270 may be used to implement the functionality of software registry 170 of FIG. 1. In certain embodiments, software registry 270 may include one or more processors 271, memory elements 272, and network interfaces 273, along with software registry management software, such as image manager 274 and patch manager 275, and software registry databases, such as image database 276 and patch database 277. In some implementations, the various illustrated components of software registry 270, and other associated systems and tools (e.g., development system 220 of FIG. 2A), may be combined, or even further divided and distributed among multiple different systems. For example, in some implementations, software registry 270 may be implemented as multiple different systems with varying combinations of the foregoing components (e.g., 271, 272, 273, 274, 275, 276, 277). In addition, some or all of the components of software registry 270 may be implemented as part of software development system 220 of FIG. 2A. Components of software registry 270 may communicate, interoperate, and otherwise interact with external systems and components (including with each other in distributed embodiments) over one or more networks using network interface 273.

In some embodiments, software registry 270 may include an image manager 274 to manage and distribute software images corresponding to various software packages hosted by software registry 270. For example, software applications (e.g., application 110 of FIG. 1) can be developed using a variety of existing software packages, and software registry 270 may host a repository of software packages that can be used by or used with those software applications. Software packages hosted by software registry 270 may be stored, in some embodiments, using software images corresponding to particular software packages. As an example, software packages that are implemented using software containers may be stored in software registry 270 using container images (i.e., images that include all components and dependencies required to run a particular software package in a software container, such as a microservice). In some embodiments, image database 276 may be used to store the software images associated with the software packages hosted by software registry 270. During development of an application, the appropriate software packages for building or updating the application may be retrieved from software registry 270. In addition, throughout the life of the application, any new versions, releases, updates, patches, bug fixes, or other revisions to those associated software packages may also be retrieved from software registry 270. For example, a software development system (e.g., development system 220 of FIG. 2A) may need to retrieve various software packages used by a software application that is under development on the software development system. Accordingly, the software development system may request the appropriate software packages from software registry 270. In some embodiments, image manager 274 may be used to retrieve the appropriate software images from image database 276 and distribute those software images (e.g., over a network) to the requesting software development system.

In some embodiments, software registry 270 may also include a patch manager 275 to manage and distribute software patches associated with software packages hosted by software registry 270. For example, new versions of software packages hosted by software registry 270 may be periodically released. Software registry 270 may be updated to store those new versions and distribute them as needed. In some cases, however, software patches may be utilized for distributing new versions of software packages. For example, patches may be used to generate new versions of software packages by applying the patches to old versions of the software packages. In this manner, if a software developer and/or development system has an older version of a particular software package that needs updating, software registry 270 may distribute a patch that can be used to generate the new version of the software package (e.g., by applying the patch to the old version), rather than re-distributing an entire copy of the new version of the software package. In some embodiments, patch database 277 may be used to store the patches associated with the software packages hosted by software registry 270, and patch manager 275 may be used to manage and distribute those software patches in response to requests received by software registry 270.

In some embodiments, development system 220 (of FIG. 2A) and software registry 270 (of FIG. 2B) may include functionality for managing container images using layer deltas. For example, for containerized applications (e.g., microservices applications), development system 220 (e.g., using version manger 233) may obtain software container images and updates from software registry 270.

In some embodiments, layer deltas may be used to facilitate management and updates of container images. For example, when development system 220 requests an updated container image from software registry 270, development system 220 may identify the previous version of the container image used by development system 220. Software registry 270 may then calculate deltas between image layers of the previous and current versions of that container image (e.g., using a binary delta calculation). In some embodiments, a binary delta or binary difference calculation may be used to calculate the difference between each layer. Software registry 270 may then create a patch based on the delta calculations. For example, in some embodiments, a binary patch utility such as xdelta3 may be used. The patch may be used, for example, to generate the updated version of the container image by applying the patch to the previous version of the container image. In some embodiments, the patch may comprise a new container layer that, if added to the previous version of the container image, results in the updated version of the container image. Software registry 270 may then transmit the patch to development system 220, and development system 220 may apply the patch to the previous version of the container image to generate the updated version of the container image. For example, rather than directly fetching every layer for an updated Docker container image, a Docker client (e.g., development system 220) can identify its existing image version to a Docker server or repository (e.g., software registry 270), and the Docker server may then calculate a patch for each layer to transfer only the differences to the Docker client. In this manner, software manager 270 may distribute patches to software developers (and development systems 220) rather than distributing the entire updated container images or the entire set of new image layers.

In some embodiments, after computing a patch, software registry 270 may also cache the patch for responding to subsequent requests for the updated container image, rather than re-computing the patch for each request.

In addition, in some embodiments, software registry 270 may use layer deltas to save storage space used for container images. For example, rather than storing entire copies of each version of a container image (or entire copies of each new layer), software registry 270 may store patches calculated using layer deltas for each version of the container image. Software registry 270 may then recreate the different versions of a container image on demand using the patches, without having to store each version of the container image. In some embodiments, development system 220 may similarly save storage space by storing patches instead of multiple versions of a container image.

In addition, in some embodiments, when a software developer releases an updated version of a container image, layer deltas may be calculated on the client-side to minimize the upload time to the container server or repository. For example, if a software developer develops an updated version of a container image using development system 220, development system 220 may compare the updated container image to the previous version, calculate differences using layer deltas, create a patch based on the differences, and send the patch to software registry 270. Software registry 270 may then use the patch to generate and store the updated container image, or it may store the patch and generate the updated container image on demand.

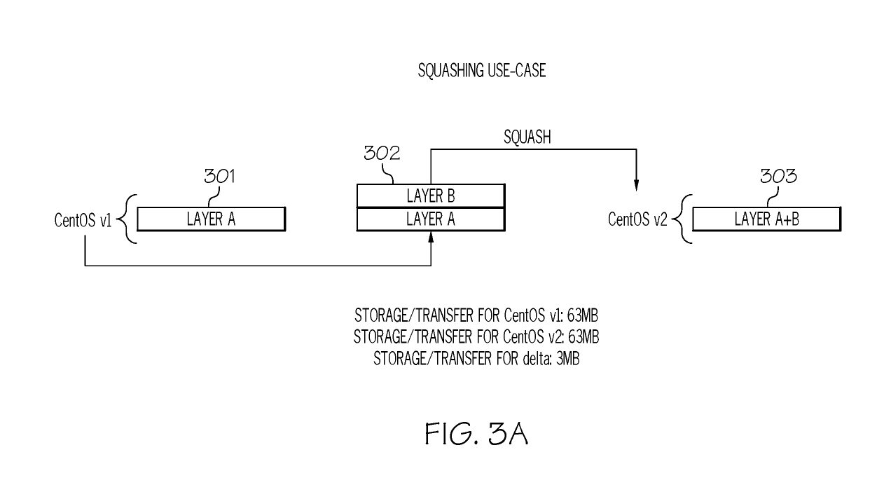

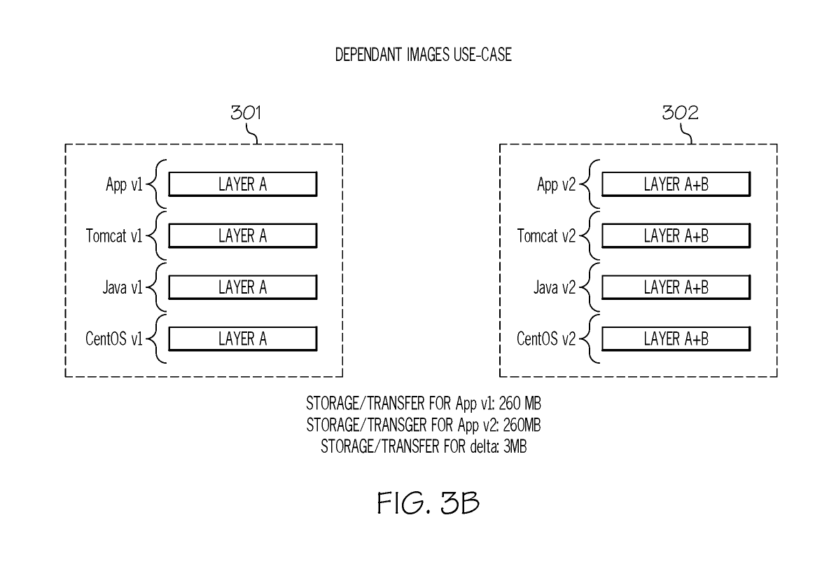

FIG. 3A illustrates an example use case 300A of container image management for squashed images. In the illustrated example, version 1 of the CentOS image (301) includes layer A. A modified version of the CentOS image (302) is then created, which contains layer B on top of layer A. However, assuming there is duplication among the layers (e.g., a duplicated file), the developers may decide to squash layers A and B in version 2 of the CentOS image (303).

While CentOS version 1 (301) and CentOS version 2 (303) are both roughly 63 megabytes (MB) in size, the difference or delta between the layers is only 3 MB. However, because the layers are squashed in version 2 of CentOS (303), existing solutions would require the entire 63 MB image to be downloaded when upgrading to CentOS version 2. Alternatively, using the layer delta functionality discussed throughout this disclosure, the delta between the layers of CentOS version 1 and CentOS version 2 can be calculated to create a patch that is only 3 MB, and the patch can then be transmitted and/or stored, requiring approximately 20 times less transmission bandwidth and/or storage space than if the entire 63 MB CentOS version 2 image (303) were transferred or stored.

FIG. 3B illustrates an example use case 300B of container image management for dependent images. In the illustrated example, an application is built on top of Apache Tomcat, Java, and CentOS. Accordingly, the container image for the application is built by adding an image for the application on top of the three base images for Tomcat, Java, and CentOS.

In the illustrated example, version 1 of the application (301) includes a single layer A for each of the underlying images. If the CentOS image is updated to include a new layer (e.g., layer B), all images of the application on top of CentOS must be rebuilt, even if the layers of the updated CentOS image are not squashed. Thus, the Java, Tomcat, and application images would all be rebuilt on top of the updated CentOS image, resulting in version 2 of the application (302).

While version 1 (301) and version 2 (302) of the application are both roughly 260 megabytes (MB) in size, the difference or delta between the layers of each version is only 3 MB. Existing solutions would require the entire set of rebuilt images to be downloaded when upgrading to version 2 of the application (302). However, using the layer delta functionality discussed throughout this disclosure, the delta between the layers of application version 1 (301) and application version 2 (302) can be calculated to create a patch that is only 3 MB, and the patch can then be transmitted and/or stored, requiring significantly less transmission bandwidth and/or storage space than if the entire 260 MB image for application version 2 (302) were transferred or stored.

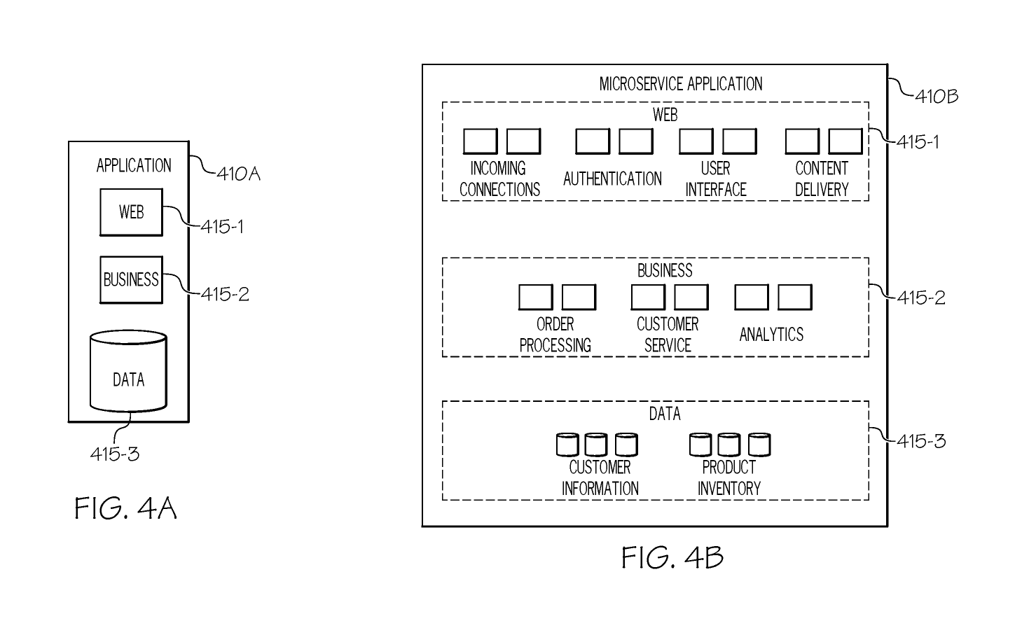

FIGS. 4A and 4B illustrate example monolithic and microservices architectures for a software application. The container or software image management functionality described throughout this disclosure can be implemented for both microservices and monolithic applications.

Monolithic-based architectures and microservice-based architectures, for example, are software design approaches that may be used to implement an application. FIG. 4A illustrates an example monolithic architecture for a software application, and FIG. 4B illustrates an example microservices architecture for the same software application. A monolithic application, for example, may be implemented as a single application that integrates all associated components and functionality. While a monolithic application may have a logically modular architecture, it is packaged and deployed as one large application. For example, in FIG. 4A, monolithic application 410A is a single application with multiple logical components 415, including web logic 415-1, business logic 415-2, and data storage logic 415-3. Monolithic applications are common, and may be straightforward to develop since many development tools (e.g., IDEs) focus on building single applications. Monolithic applications may also be relatively straightforward to deploy—the complete application package, for example, may be copied to an application server and launched.

Monolithic approaches may work well in the early stages of an application and for smaller applications. Many applications, however, grow over time and eventually become highly complex. Accordingly, monolithic applications may be inefficient to develop and maintain, as they are often too complex for any single developer to fully understand, making simple tasks such as bug fixes and feature updates very difficult. In addition, any updates to the application, even if minor, often require the entire application to be tested and redeployed. Monolithic applications also make it difficult to adopt new programming languages, frameworks, or other new software technologies. Rewriting a large, complex application (e.g., with millions of lines of code) using a new technology is often impractical, leaving developers stuck with the original technologies that were chosen at the outset. Monolithic applications can also be unreliable. Because all functionality is running within the same process, any minor bug (e.g., memory leak) or hardware failure can be fatal to the entire application. Continuous deployment may also be challenging for monolithic applications. Continuous deployment is a software development trend to continuously push new changes into production rather than sporadically release new functionality, which can be very difficult for monolithic applications since the entire application must be redeployed when any aspect is updated. Scaling monolithic applications efficiently may also be challenging, as it requires instances of the entire application to be deployed, even if only one aspect of the application needs to be scaled. In addition, monolithic applications are often deployed on hardware that is pre-scaled for peak loads. When a monolithic application outgrows its hardware, the hardware may have to be “scaled up” or upgraded rather than reconfiguring the datacenter and/or updating the software architecture of the application.

Even if the web, business, and data logic of a monolithic application is decomposed into separate applications to provide some level of developer agility and independent scaling, each logical tier often becomes its own separate monolithic application that integrates diverse functionality into a single software package, and thus may still suffer from challenges faced by monolithic applications.

While monolithic architectures may be suitable for certain types of applications, microservice-based architectures may be preferable for large, complex applications that require flexible development, deployment, and scaling (e.g., cloud-based applications). A microservices application, for example, may be implemented using multiple separate and self-contained applications, or microservices, that each provide a particular service and collectively form a fully functional application. A microservices architecture may allow each underlying microservice of an application to be independently developed, deployed, updated, and scaled, resulting in numerous efficiencies in the software development process.

For example, in FIG. 4B, microservices application 410B includes a variety of microservices 415 to implement the web logic, business logic, and data storage logic. For example, the web logic is implemented using various microservices 415-1 responsible for incoming connections, authentication, the user interface, and web content delivery. The business logic is implemented using various microservices 415-2 responsible for order processing, customer service, and analytics. The data storage logic is implemented using various microservices 415-3 responsible for managing storage of customer information and product inventory. In microservice-based architectures, each discrete function or service of an application is implemented by its own microservice, and each microservice is itself an independent application. Microservices are often designed to communicate using simple and well-known communication methods and protocols, such as lightweight RESTful APIs (i.e., application programming interfaces (API) implemented using representational state transfer (REST) architectures).

Microservices applications can be developed and maintained more efficiently, as complex applications are broken up into multiple smaller and more manageable applications, or microservices. The functionality of each microservice often is so focused that a particular microservice can be used for multiple different applications. Microservice-based architectures also enable the underlying microservices to be developed independently by different software development teams. Microservices can be developed using the most appropriate programming language and/or technology for each microservice, rather than being stuck with obsolete technologies or technologies that may only be suitable for certain types of microservices. The independent, distributed nature of microservice-based applications also enables them to be independently deployed and independently updated. In addition, microservice-based architectures facilitate rolling updates, where only some instances of a particular microservice are updated at any given time, allowing buggy updates to be “rolled back” or undone before all instances of the microservice are updated.

Microservice-based architectures also enable each microservice to be scaled independently, resulting in more efficient load balancing. Microservices can be scaled by deploying any number of instances of a particular microservice needed to satisfy the capacity and availability constraints of that microservice. For example, if there is a spike in incoming traffic to an application, the microservice responsible for handling incoming connections could be scaled without scaling other microservices of the application. A microservice can also be deployed on the hardware that is best-suited for its respective requirements and functionality.

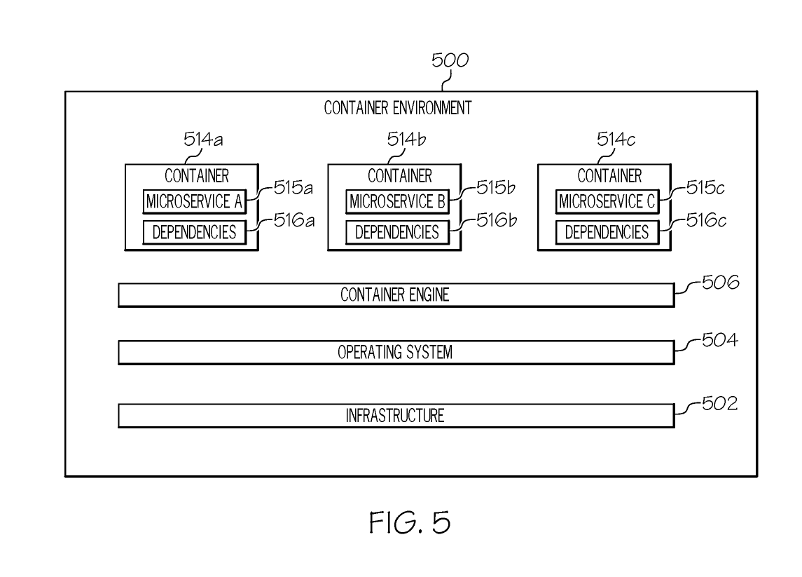

Microservices applications can be implemented using virtual machines or software containers. Software containers can be an effective complement to a microservices application, as they can be used to ensure that each microservice runs the same in any environment or infrastructure, out-of-the-box. A microservices application, for example, could be implemented using the software container environment described in connection with FIG. 5.

Microservice-based architectures are integral to various software technology advancements, including cloud-based applications and services, continuous integration and continuous deployment (CI/CD), and software container technology, among other examples.

FIG. 5 illustrates an example software container environment 500. The container image management functionality described throughout this disclosure may be used for applications implemented using containerized environments 500, such as containerized microservices applications.

In some cases, for example, software applications may be implemented using software containers, such as Docker containers, containers based on the Open Container Initiative (OCI), and/or any other software container implementation. Analogous to shipping containers, software containers may package a particular software component with all of its dependencies to ensure that it runs the same in any environment or infrastructure, out-of-the-box. For example, a software container may package everything required to run a particular software component, such as the code, software libraries, APIs, configuration, files, runtime environment, and any other associated tools or applications.

Software containers enable applications to be migrated across various infrastructures and environments without any modifications or environment-specific configurations. For example, applications can be migrated to or from local workstations, development servers, test environments, and/or production environments. Software containers also enable applications to be developed using the best programming languages and tools for each application, without any internal conflicts from the requirements of different applications. Many inefficiencies of software development and deployment are eliminated with software containers, such as time spent configuring development and production environments, concerns about inconsistencies between development and production environments, and so forth. Software containers also avoid locking developers into any particular platform, software technology, and/or vendor.

Software containers running on the same machine may also share a host operating system, thus avoiding the inefficiencies of virtual machines, which each require their own guest operating system on top of the host operating system. Accordingly, in comparison to virtual machines, software containers may launch faster and use less memory.

Software components implemented using software containers may be stored as container images, which may include all components and dependencies required to run a particular software component in a software container. A container image, for example, may be a file format used to package the components and dependencies of a containerized software component. Container images may be constructed using layered filesystems that share common files, resulting in less disk storage and faster image downloads. In some cases, container images may be hosted by a software registry (e.g., software registries 170 of FIG. 1 or 270 of FIG. 2B) to provide a central repository for distributing container images to software developers. Examples of container images include Docker container images, container images based on the Open Container Initiative (OCI), and/or any other container image format. The Open Container Initiative (OCI), for example, is a collaborative effort by the software industry to develop an open, vendor-neutral, and portable implementation of software containers, to ensure that compliant software containers are portable across all major operating systems and platforms that are also compliant. The OCI implementation is based on the implementation of Docker containers.

Software container environment 500 illustrates an example of a containerized implementation for a microservices application. While microservice-based architectures have many benefits, managing the microservices of an application can become challenging as the application grows and the number of microservices increases. For example, each microservice may have unique build and configuration requirements, including its own software dependencies, which may require each microservice to be custom built and/or configured, additional software to be installed, and so forth. Accordingly, software containers can be an effective complement to a microservices application, as they can be used to ensure that each microservice runs the same in any environment or infrastructure, out-of-the-box. Software containers can be used to implement microservices applications, for example, by packaging each microservice of an application into a separate software container.

In the illustrated example, container environment 500 includes infrastructure 502, operating system 504, container engine 506, and software containers 514. Infrastructure 502 includes the underlying hardware and/or software infrastructure used to provide the containerized environment, such as an application server (e.g., application server 130 of FIG. 1). Operating system 504 is operating system software executing on infrastructure 502, which can be any operating system adapted to provide a containerized environment, such as Linux, other UNIX variants, Microsoft Windows, Windows Server, Mac OS, Apple iOS, and/or Google Android, among others. Container engine 506 includes software responsible for providing and managing the containerized environment 500, such as a Docker container engine, an OCI-based container engine, and/or any other type of software container engine. Software containers 514 are containers that execute distinct software components in their own respective environments. In the illustrated example, containers 514 each include a microservice 515 and its associated dependencies 516. For example, container 514a includes microservice A (515a) and its dependencies (516a), container 514b includes microservice B (515b) and its dependencies (516b), and container 514c includes microservice C (515c) and its dependencies (516c). These microservices 515 may collectively form a microservices application that is executing on infrastructure 502 in a containerized environment 500.

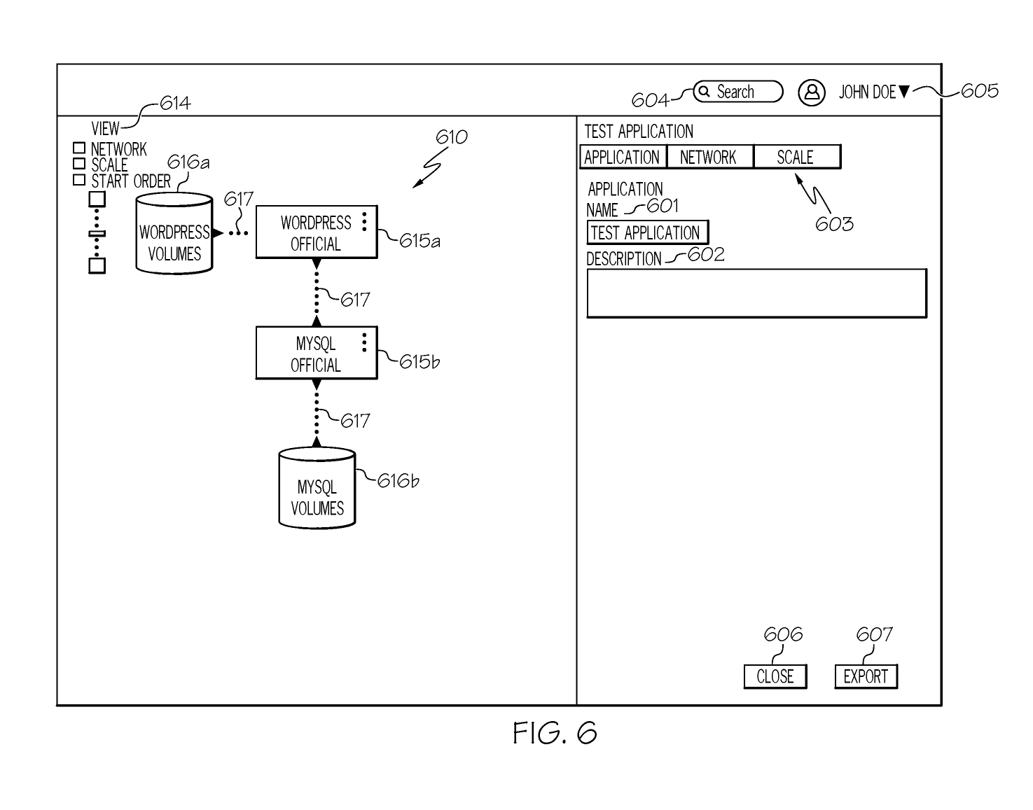

FIG. 6 illustrates an example application modeling and development tool 600. Modeling and development tool 600 may be used, for example, to provide application modeling functionality and/or other application development functionality. For example, modeling and development tool 600 may be used to model the architecture of a software application, and/or to facilitate configuration, maintenance, deployment, and/or testing of an application. In some embodiments, modeling tool 600 may include or facilitate the container image management functionality described throughout this disclosure. In some embodiments, for example, modeling tool 600 may be used to provide the functionality described in connection with development system 220 of FIG. 2A, such as the application modeler 232, version manager 233, and/or any other component of development system 220.

Modeling tool 600 may be used to design, configure, and/or update the architecture of a software application and its underlying components. Software applications may be composed of, include, and/or rely on a variety of underlying software components. For example, applications may be implemented using a variety of software design approaches (e.g., monolithic or microservices architectures), and with a variety of software modules, components, containers, services, microservices, and/or external services, among other examples. Modeling tool 600 may be used to design or configure an application, for example, by identifying each underlying component, along with its functionality and responsibilities, configuration, version, and/or relationship to other components, among other information. This configuration information for the application may be created, obtained, stored, and/or displayed using modeling tool 600. Modeling tool 600 may display the application's design or architecture, for example, by displaying graphical representations of each underlying software component of the application (including, for example, the name, version, and/or configuration of each component), the relationships between the underlying components, and so forth.

In some embodiments, modeling tool 600 may be a tool used for modeling and/or developing microservices applications, such as the Yipee.io tool or other microservices development tool. Microservices applications, for example, may be implemented by packaging a variety of microservices into separate software containers. In the illustrated embodiment, modeling tool 600 is used to model the architecture of a microservices application 610 and its associated microservices 615. For example, modeling tool 600 displays representations of each component of application 610, including microservices 615 and storage volumes 616, and also identifies the relationships 617 among those components. Modeling tool 600 also provides various viewing options 614 for application 610, including network, scale, and start order views. Modeling tool 600 also displays modifiable configuration fields for application 610, including the name 601 and description 602 of the application, among others. In the illustrated embodiment, the configurable fields and parameters are broken up into categories 603 (i.e., the application, network, and scale categories 603). Modeling tool 600 also provides search functionality 604, identifies the current user or developer 605, and includes buttons for closing 606 and/or exporting 607 the configuration of an application 610.

In some embodiments, modeling and development tool 600 may also provide other microservices development functionality, including configuration, maintenance, and/or deployment of microservices applications. For example, modeling and development tool 600 may be used to configure the orchestration environment for a microservices application, such as an orchestration environment provided by Kubernetes, Docker Swarm, and/or Apache Mesos, among other orchestration tools. Orchestration tools, for example, may be used to facilitate and/or automate deployment, scaling, and/or operation of containerized applications.

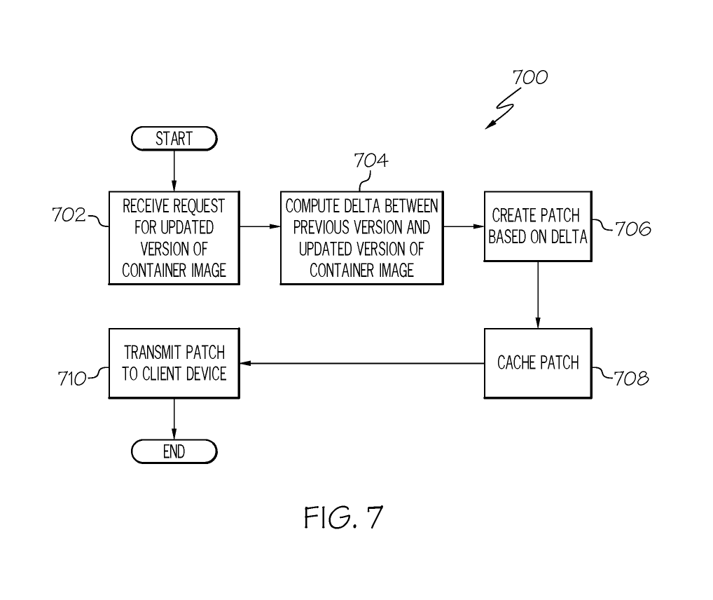

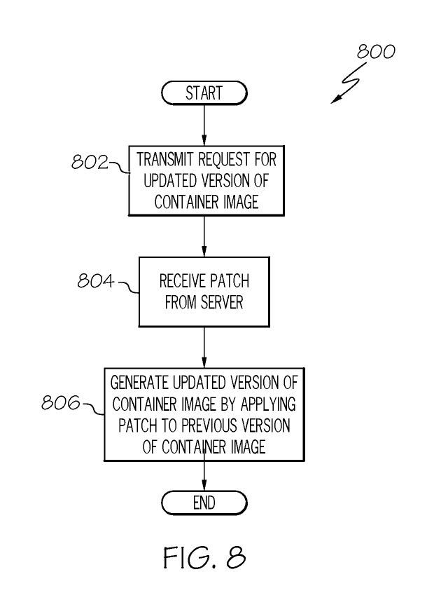

FIG. 7 illustrates a flowchart 700 for an example embodiment of server-side container image management using layer deltas. Flowchart 700 may be implemented, in some embodiments, by the components described throughout this disclosure (e.g., software registry 270 of FIG. 2B and/or development system 220 of FIG. 2A).

The flowchart may begin at block 702 by receiving a request from a client device for an updated version of a container image. In some embodiments, the request may identify the previous version of the container image used by the client device. The flowchart may then proceed to block 704 to compute a delta between layers of the previous version of the container image and the updated version of the container image. The flowchart may then proceed to block 706 to create a patch based on the computed delta. In some embodiments, for example, a binary delta or binary difference calculation may be used to calculate the difference between each layer. For example, a binary patch utility such as xdelta3 may be used to calculate the deltas and create the patch.

The flowchart may then proceed to block 708 to cache the patch for responding to subsequent requests for the updated container image. The flowchart may then proceed to block 710 to transmit the patch to the client device that requested the updated container image. The client device may then use the patch, for example, to generate the updated version of the container image by applying the patch to the previous version of the container image.

At this point, the flowchart may be complete. In some embodiments, however, the flowchart may restart and/or certain blocks may be repeated. For example, in some embodiments, the flowchart may restart at block 702 in order to continue receiving and processing requests for updated container images.

FIG. 8 illustrates a flowchart 800 for an example embodiment of client-side container image management using layer deltas. Flowchart 800 may be implemented, in some embodiments, by the components described throughout this disclosure (e.g., development system 220 of FIG. 2A and/or software registry 270 of FIG. 2B).

The flowchart may begin at block 802 by transmitting a request for an updated version of a container image. In some embodiments, for example, the request may be from a client device to a container repository or server. In addition, the request may identify the previous version of the container image used by the client device.

The flowchart may then proceed to block 804 to receive a patch from a server. The server may be, for example, a container repository used to store and distribute container images and patches. In some embodiments, for example, the patch may be based on a delta between container layers of the previous version of the container image and the updated version of the container image. For example, in some embodiments, the delta is based on a binary delta calculation.

The flowchart may then proceed to block 806, where the client device may generate the updated version of the container image by applying the patch to the previous version of the container image.

At this point, the flowchart may be complete. In some embodiments, however, the flowchart may restart and/or certain blocks may be repeated. For example, in some embodiments, the flowchart may restart at block 802 in order to continue requesting updated versions of container images.

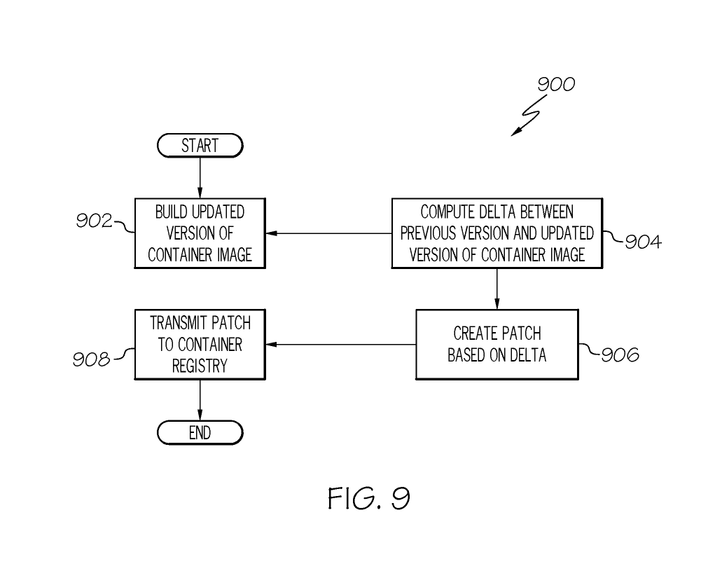

FIG. 9 illustrates a flowchart 900 for an example embodiment of pushing container images using layer deltas. Flowchart 900 may be implemented, in some embodiments, by the components described throughout this disclosure (e.g., development system 220 of FIG. 2A and/or software registry 270 of FIG. 2B).

The flowchart may begin at block 902 by building an updated version of a container image. The flowchart may then proceed to block 904 to compute a delta between layers of the previous version of the container image and the updated version of the container image. In some embodiments, for example, a binary delta or binary difference calculation may be used to calculate the difference between each layer. For example, a binary patch utility such as xdelta3 may be used. The flowchart may then proceed to block 906 to create a patch based on the computed delta. The flowchart may then proceed to block 908 to transmit the patch to a container registry. For example, in some embodiments, when a software developer releases an updated version of a container image, the layer deltas and associated patch may be created on the client-side to minimize the upload time to the container registry or server. The patch may then be transmitted from the client to the container registry or server.

At this point, the flowchart may be complete. In some embodiments, however, the flowchart may restart and/or certain blocks may be repeated. For example, in some embodiments, the flowchart may restart at block 902 in order to repeat the process for another updated version of a container image.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
receiving, from a client device, a request for an updated version of a container image, the request comprising an identification of a previous version of the container image;
determining a delta between container layers of the previous version of the container image and the updated version of the container image;
generating, based on the delta, a patch to generate the updated version of the container image when the patch is applied to the previous version of the container image; and
transmitting the patch to the client device.

2. The method of claim 1, wherein the patch comprises a new container layer that, if added to the previous version of the container image, results in the updated version of the container image.

3. The method of claim 1, further comprising caching the patch for responding to subsequent requests for the updated version of the container image.

4. The method of claim 3, further comprising:
receiving, from a second client device, a second request for the updated version of the container image, the second request comprising the identification of the previous version of the container image;
retrieving the patch from a cache; and
transmitting the patch to the second client device.

5. The method of claim 3, further comprising:
receiving, from a second client device, a second request for the updated version of the container image;
retrieving the patch from a cache;
generating the updated version of the container image using the patch; and
transmitting the updated version of the container image to the second client device.

6. The method of claim 1, wherein the delta is determined using a binary delta calculation.

7. The method of claim 1, further comprising:
receiving a second patch to generate an updated version of a second container image when the second patch is applied to a previous version of the second container image, wherein the second patch is based on a delta between container layers of the previous version of the second container image and the updated version of the second container image;
caching the second patch for responding to requests for the updated version of the second container image;
receiving, from a second client device, a second request for the updated version of the second container image, the second request comprising the identification of the previous version of the second container image;
retrieving the second patch from a cache; and
transmitting the second patch to the second client device.

8. A system comprising:
a processor device;
a memory element; and
a container image manager stored in the memory element, the container image manager comprising one or more instructions executable by the processor device, the one or more instructions configured to:
receive, from a client device, a request for an updated version of a container image, the request comprising an identification of a previous version of the container image;
determine a delta between container layers of the previous version of the container image and the updated version of the container image;
generate, based on the delta, a patch to generate the updated version of the container image when the patch is applied to the previous version of the container image; and
transmit the patch to the client device.

9. The system of claim 8, wherein the patch comprises a new container layer that, if added to the previous version of the container image, results in the updated version of the container image.

10. The system of claim 8, wherein the one or more instructions are further configured to cache the patch for response to subsequent requests for the updated version of the container image.

11. The system of claim 10, wherein the one or more instructions are further configured to:
receive, from a second client device, a second request for the updated version of the container image, the second request comprising the identification of the previous version of the container image;
retrieve the patch from a cache; and
transmit the patch to the second client device.

12. The system of claim 10, wherein the one or more instructions are further configured to:
receive, from a second client device, a second request for the updated version of the container image;
retrieve the patch from a cache;
generate the updated version of the container image using the patch; and
transmit the updated version of the container image to the second client device.

13. The system of claim 8, wherein the one or more instructions are further configured to determine the delta using a binary delta calculation.

14. The system of claim 8, wherein the one or more instructions are further configured to:
receive a second patch to generate an updated version of a second container image when the second patch is applied to a previous version of the second container image, wherein the second patch is based on a delta between container layers of the previous version of the second container image and the updated version of the second container image;
cache the second patch for responding to requests for the updated version of the second container image;
receive, from a second client device, a second request for the updated version of the second container image, the second request comprising the identification of the previous version of the second container image;
retrieve the second patch from a cache; and
transmit the second patch to the second client device.

15. A non-transitory computer readable medium having program instructions stored thereon that are executable to cause a computer system to perform operations comprising:
receiving, from a client device, a request for an updated version of a container image, the request comprising an identification of a previous version of the container image;
determining a delta between container layers of the previous version of the container image and the updated version of the container image;
generating, based on the delta, a patch to generate the updated version of the container image when the patch is applied to the previous version of the container image; and
transmitting the patch to the client device.

16. The computer readable medium of claim 15, wherein the patch comprises a new container layer that, if added to the previous version of the container image, results in the updated version of the container image.

17. The computer readable medium of claim 15, further comprising caching the patch for responding to subsequent requests for the updated version of the container image.

18. The computer readable medium of claim 17, further comprising:
receiving, from a second client device, a second request for the updated version of the container image, the second request comprising the identification of the previous version of the container image;
retrieving the patch from a cache; and
transmitting the patch to the second client device.

19. The computer readable medium of claim 17, further comprising:
receiving, from a second client device, a second request for the updated version of the container image;
retrieving the patch from a cache;
generating the updated version of the container image using the patch; and
transmitting the updated version of the container image to the second client device.

20. The computer readable medium of claim 15, wherein the delta is determined using a binary delta calculation.
